(19) United States
(12) Patent Application Publication
(10) Pub. No.: US 2025/0009003 A1
(43) Pub. Date: Jan. 9, 2025

(54) METHOD AND SYSTEMS FOR PRODUCING SHELF STABLE PLANT-BASED HYDROGELS

(71) Applicant: Bluana Foods SRL, Gura Humorului (RO)

(72) Inventor: Marco Iotti, Penthéréaz (CH)

(21) Appl. No.: 18/763,301

(22) Filed: Jul. 3, 2024

Related U.S. Application Data
(60) Provisional application No. 63/524,742, filed on Jul. 3, 2023.

(51) Int. Cl. A23L 35/00; A23L 3/10; A23L 5/00; A23L 29/256

(52) U.S. Cl. CPC A23L 35/10; A23L 3/10; A23L 5/51; A23L 29/256

(57) ABSTRACT

Provided herein are shelf-stable, layered foods and systems and methods for producing the same. In at least one embodiment, the layered foods comprise a first layer comprising a first hydrogel component and a second layer comprising a second hydrogel component, wherein the first and second hydrogel components are formed from one or more biomaterials extracted from one or more plant-based sources.

### CROSS-REFERENCE TO RELATED APPLICATIONS

The present application claims the benefit of U.S. Provisional Patent Application No. 63/524,742, filed Jul. 3, 2023, which is incorporated herein by reference in its entirety.

### TECHNICAL FIELD OF THE DISCLOSURE

The present disclosure relates to systems and methods for preparing edible (e.g., fit for human consumption) plant-based, and shelf-stable hydrogel products.

### BACKGROUND

Fast Moving Consumer Goods (FMCGs) include nondurable products which are produced, marketed, sold, and consumed rapidly, and sold at relatively low prices. Generally, FMCGs are quickly replaced on store shelves because they are purchased frequently and spontaneously. However, edible FMCGs may not have high nutritional density and/or may end up discarded if not sold within their shelf lives. Scarcity of resources and global warming pose challenges in sourcing the feed ingredients for FMCGs. Additional challenges may be present in ensuring safe, sustainable, and cost-effective transportation, manufacturing, and packaging practices for FMCGs produced at scale.

As a result, there is a long-felt, but unsolved need for FMCGs with improved stability, nutritional density, and shelf lives. Further, there is a need for improved manufacturing and packaging processes for FMCGs produced at scale.

### BRIEF SUMMARY

Briefly described, aspects of the present disclosure generally relate to plant-based shelf-stable hydrogels for human consumption, as well as systems and methods for producing the same. According to a first aspect, the present disclosure relates to a method of manufacturing an edible, plant-based, shelf-stable hydrogel, the method comprising: selecting a feed source, the feed source comprising one or more plant-based materials; extracting one or more biomaterials from the one or more plant-based materials; forming an emulsion from the one or more biomaterials; extruding an edible hydrogel material from the emulsion; filling a container with the edible hydrogel material; and sealing the container.

According to a second aspect, the method of the first aspect, wherein an operating temperature is maintained to at least about 70-degrees C. to about 80-degrees C.

According to a third aspect, the method of the second aspect or any other aspect, the step of extruding a consumable hydrogel material from the emulsion, further comprising: adding a reticulation agent to the emulsion to prompt thickening.

According to a fourth aspect, the method of the second aspect or any other aspect, further comprising the step of separating the consumable hydrogel material into a first hydrogel component and a second hydrogel component.

According to a fifth aspect, the method of the fourth aspect or any other aspect, the step of filling a container with consumable hydrogen material, further comprising: dispensing the first hydrogel component along an inner portion of the container; and dispensing the second hydrogel component atop and along the first hydrogel component.

According to a sixth aspect, the method of the fifth aspect, wherein a ratio of the first hydrogel component to the second hydrogel component by volume is approximately 3:1.

According to a seventh aspect, the method of the second aspect, wherein the step of sealing the container occurs at MAP conditions.

The present disclosure also relates to a shelf-stable, layered food that, in some embodiments, can be used as an alternative to seafood products. According to an eighth aspect, the present disclosure relates to a shelf-stable, layered food, the layered food comprising: a first layer comprising a first hydrogel component; and a second layer comprising a second hydrogel component; wherein the first and second hydrogel components are formed from one or more biomaterials extracted from one or more plant-based sources.

According to a ninth aspect, the layered food of the eighth aspect, wherein a water content for the layered food is over approximately 25% by weight.

According to a tenth aspect, the layered food of the ninth aspect, wherein the layered food is resistant to weight loss and spoilage over time.

According to an eleventh aspect, the layered food of the eighth aspect, wherein a ratio of the first hydrogel component to the second hydrogel component by volume is approximately 3:1.

According to a twelfth aspect, the layered food of the eighth aspect, wherein the first layer includes a first color and the second layer includes a second color.

According to a thirteenth aspect, the layered food of the twelfth aspect, wherein the layered food comprises alternating first and second layers.

According to a fourteenth aspect, the layered food of the eighth aspect, wherein a first of the one or more biomaterials comprises carrageenan.

The present disclosure also relates to a system for manufacturing a plant-based, shelf-stable hydrogel. According to a fifteenth aspect, the present disclosure relates to system for manufacturing an edible, plant-based, shelf-stable hydrogel, the system comprising: a mixture and extraction unit, the mixture and extraction unit configured to extract one or more biomaterials from a plant-based feed material, wherein the one or more biomaterials is processed to form a hydrogel material; a filling unit, the filling unit configured to extrude the hydrogel material into one or more containers; and a sealing unit, the sealing unit configured to seal the one or more containers of hydrogel material to form a sealed hydrogel product.

According to a sixteenth aspect, the system of the fifteenth aspect, wherein the mixture and extraction unit is further configured to separate the hydrogel material into a first hydrogel component and a second hydrogel component.

According to a seventeenth aspect, the system of the sixteenth aspect, wherein the first hydrogel component and the second hydrogel component are different.

According to an eighteenth aspect, the system of the seventeenth aspect, further comprising a distribution unit configured to transport the first hydrogel component and the second hydrogel component from the mixture and extraction unit to the filling unit via one or more feeding components.

According to a nineteenth aspect, the system of the eighteenth aspect, wherein the filling unit further comprises a dosing component configured to: receive the first hydrogel component and the second hydrogel from the one or more feedings components, and dispense the first hydrogel component and the second hydrogel in a pattern into the one or more containers.

According to a twentieth aspect, the system of the nineteenth aspect, wherein a ratio of the first hydrogel component to the second hydrogel component by volume is approximately 3:1.

### BRIEF DESCRIPTION OF THE DRAWINGS

FIG. 1 is a schematic of an exemplary system for producing plant-based, shelf-stable hydrogel products, according to one embodiment of the present disclosure;

FIG. 2A is a schematic of an exemplary component of the system of FIG. 1;

FIG. 2B is a schematic of an exemplary component of the system of FIG. 1; and

FIG. 3 is a schematic of an exemplary hydrogel product, according to one embodiment of the present disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the disclosure” does not require that all embodiments of the disclosure include the discussed feature, advantage or mode of operation.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

According to some embodiments, this disclosure relates to FMCGs including edible hydrogel products designed for human consumption. In light of global food security issues, it may be advantageous to produce sustainably sourced, manufactured, and/or packaged hydrogel products having improved nutritional composition. Further, it may be advantageous to produce hydrogel products having improved shelf lives (e.g., to reduce waste) and/or sourced from upcycled/customizable ingredients (e.g., to reduce carbon footprints). For instance, hydrogel products made from plant-based sources may remain fresh for longer periods of time and may provide improved nutritional density and varying flavors/textures for vegetarian or vegan diets, thus providing viable alternatives to many meat-based products. Thus, in some embodiments, the present disclosure further relates to nutritious and shelf-stable, plant-based hydrogel products and systems and methods for producing the same.

According to particular embodiments, this disclosure relates to consumable hydrogel products produced from plant-based sources to provide healthy, sustainable, and/or versatile alternatives for fish, meat, and/or dairy products. Such hydrogel products may be include “extracted biomaterials” such as, but not limited to, natural polymers (e.g., alginate, pectin, agar, carrageenan, starch, proteins, cellulose derivatives, other bioactive compounds, etc.), polyphenols (e.g., flavanols, anthocyanins, benzoic acid, tannin, lignin, stilbenes, cinnamic acid, etc.), terpenoids (carotenoids, terpenes, triterpenes, phytosterols, iridoids), organo-sulfurs, and alkaloids derived from sustainable plant-based sources. In some embodiments, the extracted biomaterials may provide antioxidant, antimicrobial, and/or biodegradable properties for the hydrogel products. Exemplary plant-based sources include, but are not limited to, algae, seaweed, tapioca, potatoes, corn, leaves, seeds, fruits, roots, stems, mushrooms, other agro-industry byproducts, or any other suitable sources that can provide improved flavors, nutrition, resistance to spoilage, water retention, and/or texture.

Additionally, hydrogel manufacturing processes (e.g., injection molding) can create custom forms and shapes directly within primary packaging used for encasing hydrogel products. Such processes may produce hydrogels with customizable encapsulation ability, controlled release of flavor/nutrition, and modification of textures (e.g., fat-replacement to reduce calorie content in foods, stabilization of emulsions). Thus, in some embodiments, the present disclosure further relates to systems and methods for producing plant-based hydrogel products comprising customizable shapes, flavors, and textures relating to particular compositions of natural polymers, minerals, vitamins, etc. derived from plant-based sources.

According to some embodiments, this disclosure relates to shelf-stable and plant-based hydrogels having improved moisture. Generally, hydrogels can absorb and retain water within a cross-linked polymer structure, thus retaining varying amounts of moisture that may be beneficial for food preservation. Thus, the hydrogel products may have a water content (by weight) of at least about 15% to 25%, about 20% to 30%, about 25% to 35%, about 30% to 40%, about 35% to 45%, or higher than about 25%. In some cases, the improved water content of the hydrogel products allows for low transportation costs (e.g., resistance to weight loss and spoilage) and improved texture/flavor protection over the course of their shelf lives, wherein the water content/moisture retention may improve the ability of the hydrogel products to withstand refrigeration. Accordingly, the systems and methods as disclosed herein may allow for desirable reductions in waste and greenhouse gas emissions due to moisture retention and consequent extension of shelf lives for the plant-based hydrogel products.

According to some embodiments, this disclosure relates to plant-based hydrogel product that simulate seafood products such as, but not limited to, fish for use in sushi. For instance, the hydrogel product may be colored and/or layered to visually simulate stripes or any other suitable pattern to simulate a natural or appetizing appearance. Additionally, the particular plant-based material sources used in the manufacturing process may impart similar tastes/textures as certain seafood products. In one non-limiting example, the hydrogel product may comprise colored layers (e.g., alternating orange and white layers), flavors, and textures to simulate salmon fillets for use in vegetarian or vegan sushi. Other exemplary hydrogel products may simulate eel, cod, or mackerel fillets, or any other similar seafoods comprising fillets.

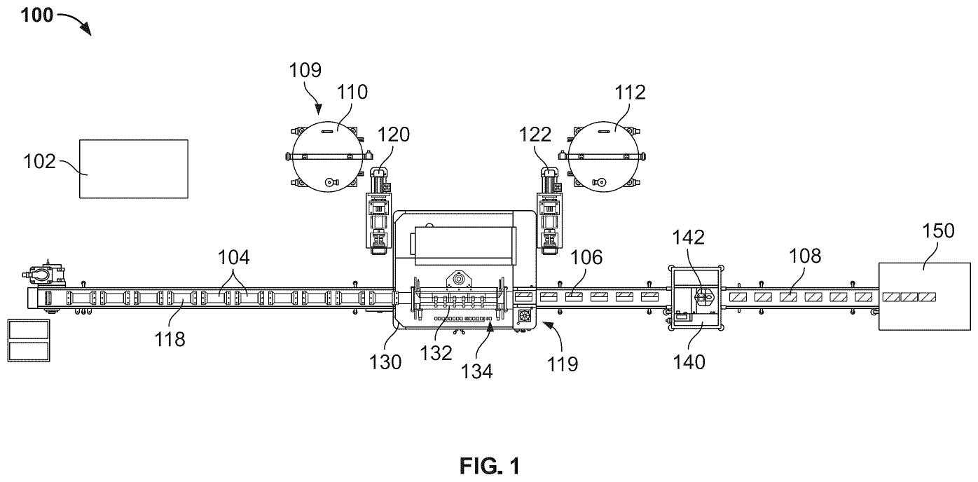

Turning now to FIG. 1, one embodiment of a system 100 for producing shelf-stable, plant-based hydrogels is shown. The system 100 may include a database 102, a mixing and extraction unit 109, a distribution unit 119, a filling unit 130, a sealing unit 140, and a collection unit 150. For example, a movable unit 118 (e.g., conveyor belt) may input one or more empty containers 104 (e.g., a sachet, tray, etc.) to the filling unit 120 to output one or more filled containers 106. Next, the movable unit 118 may input the one or more filled containers 106 to the sealing unit 140 to output one or more sealed containers 108. Then, the movable unit 118 may input the one or more sealed containers 108 to the collection unit 150. In some embodiments, the movable unit 118 may be an industrial conveyor belt or other similar transportation unit. In some cases, one or more units or portions of the system 100 may be modular. Each unit will be described in detailed herein.

In some embodiments, the mixing and extraction unit 109 may process a fresh feed stock comprising plant-based source materials (e.g., algae, mushrooms, etc.) to isolate one or more desired extracted biomaterials (e.g., natural polymers, polyphenols, terpenoids, organo-sulfurs, alkaloids, etc.). The mixing and extraction unit 109 may process the fresh feed stock at high operating temperatures (e.g., over about 100-degrees C.) via any suitable technique without departing from the principles of this disclosure, including (but not limited to) milling, boiling, acidic extraction, alkaline extraction, or chemical modification. The extracted biomaterials may then form an emulsion or any other suitable type of mixture. In certain embodiments, further purification (e.g., via filtration, centrifugation, precipitation, drying, etc.) of the extracted biomaterials may be desirable prior to hydrogel formation.

In some embodiments, additional ingredients may be added or injected into the emulsion at the mixing and extraction unit 109 to prompt reticulation (e.g., hydrogel formation). For instance, water or liquid soluble ingredients (e.g., reticulation agents, texturizing agents, liquid/powdered proteins, vitamins, minerals, etc.) may be injected into the emulsion to prompt reticulation or thickening. In some cases, the reticulation agents may be injected into the emulsion at a lowered operating temperature, such as about 60-degrees C., 60 to 70-degrees C., 65 to 75-degrees C., 70 to 80-degrees C., 75 to 85-degrees C., 80 to 90-degrees C., 85 to 95-degrees C., 90 to 100-degrees C., or about over 100-degrees C. Further, as the temperature is lowered and the viscosity of the emulsion increases, additional extracted biomaterials may be injected. In one non-limiting example, extracted carrageenan may be added for improved thickening or stabilization of the emulsion. Other exemplary biomaterials can be added at this stage, including, but not limited to, konjac flower, agar-agar, starch, modified starch, carruba extract, xanthan gum, and trehalose.

In some embodiments, the mixing and extraction unit 109 may extrude a hydrogel material once a desirable composition and/or consistency is achieved for the emulsion (e.g., when the viscosity of the emulsion is higher than that of a Newtonian liquid). The extruded hydrogel material may then be stored for downstream processing within the system 100. In some cases, portions of the overall emulsion may be separated at various stages of thickening in order to inject different compositions of ingredients or extracted biomaterials for the different portions to achieve particular flavors, colors, or textures for different layers comprising the overall hydrogel product. In some embodiments, the mixing and extraction unit 109 may further comprise one or more tanks to store the extruded hydrogel material. In some embodiments, a first tank 110 may retain hydrogel material having a particular color and/or flavor while a second tank 112 may retain hydrogel material having a different color and/or flavor. In one non-limiting example, the first tank 110 may retain orange-colored hydrogel material while the second tank may retain white-colored hydrogel material. In some cases, the hydrogel material may be split between the first tank 110 and the second tank 112 according to a defined ratio.

In some embodiments, the distribution unit 119 may facilitate transport (e.g., via pumping, via gravity) of the extruded hydrogel material from the mixing and extraction unit 109 (e.g., from the one or more tanks 110, 112) to the filling unit 130 via one or more feeding units 120, 122. The one or more feeding units 120,122 may be pumps or other like components. In some embodiments, portions of the hydrogel material may be separated (or remain separated) within the distribution unit 119 in order to maintain varying flavors, colors, textures, etc. for different layers of the overall hydrogel product. In some embodiments, a first feeding unit 120 may facilitate the transport of hydrogel material from the first tank 110 while a second feeding unit 122 may facilitate the transport of hydrogel material from the second tank 112. In one non-limiting example, the first feeding unit 120 transports orange-colored hydrogel material from the first tank 110 to the filling unit 130 while the second feeding unit 122 transports white-colored hydrogel material from the second tank 112 to the filling unit 130.

In some embodiments, the filling unit 130 may operate cyclically to create a desired pattern of hydrogel material, for example, one or more layers of hydrogel material. For instance, the filling unit 130 may include one or more filling ports 132, 134 designed to selectively receive the hydrogel material from the mixing and extraction unit 109. Thus, in some embodiments, the one or more filling ports 132, 134 may include filling valves. Generally, the filling unit 130 fills an inner portion of the empty containers 104 with hydrogel material, thereby producing filled containers 106. In one non-limiting example, the first filling port 132 may receive the orange-colored hydrogel material from the first feeding unit 120 while the second filling port 134 may receive the white-colored hydrogel material from the second feeding unit 122.

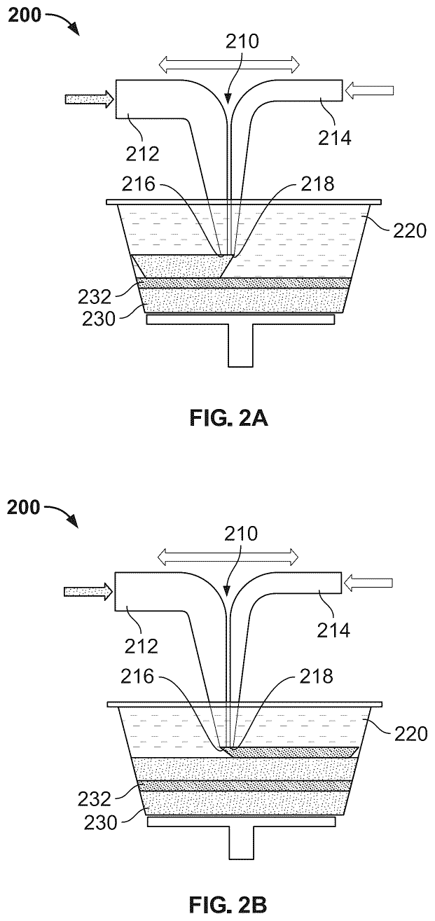

Turning now to FIGS. 2A and 2B, one embodiment of a filling subsystem 200 is shown, wherein the filling subsystem 200 may be designed to load the empty containers 104 with a plurality of layers of hydrogel material, thereby producing filled containers 106. Here, the filling subsystem 200 may comprise a dosing component 210 having a first input end 212, a second input end 214, a first output end 216, and a second output end 218. In some embodiments, the dosing component 210 may be a dosing piston while in other embodiments, the dosing component 210 may be a multi-inlet and outlet nozzle. In some embodiments, a first hydrogel component may fill a first portion of the dosing component 210 by entering the first input end 212 from the filling port 132 of the filling unit 130. A second hydrogel component may fill a second portion of the dosing component 210 by entering the second input end 214 from the filling port 134 of the filling unit 130.

In some embodiments, the dosing component 210 may then traverse a length roughly equivalent to a length of an underlying container 220 and controllably extrude or dispense the first hydrogel component via the first output end 216 and in a first direction (see FIG. 2A). Then, the dosing component 210 may traverse the length of the underlying container 220 and controllably extrude or dispense the second hydrogel component via the second output end 218 and in a second direction atop and along the first hydrogel component (see FIG. 2B). In some embodiments, the dosing component 210 may continue to controllably extrude the first and second hydrogel components in a back-and-forth pattern until the underlying container 220 is filled with alternating layers of hydrogel components. In one non-limiting example, one layer of the first hydrogel component may comprise a volume of about 40 to 50 mL, or about 45 to 55 ml, or about 50 to 60 mL, or about 55 to 65 mL, or about 60 to 70 mL; one layer of the second hydrogel component may comprise a volume of about 5 to 15 mL, or about 10 to 20 mL, or about 15 to 25 mL, or about 20 to 30 mL.

In some embodiments, the container (e.g., container 104, 106, 220) may comprise an internal volume designed to hold about 100 to 150 gr, 125 to 175 gr, 150 to 200 gr, 175 to 225 gr, 200 to 250 gr, 225 to 275 gr, or 250 to 300 gr of overall hydrogel product 200. In some embodiments, a height of the container may measure about 40 to 60 mm, 50 to 70 mm, 60 to 80 mm, 70 to 90 mm, 80 to 100 mm, 90 to 110 mm, 100 to 120 mm, or 110 to 130 mm. In some embodiments, the containers may be sterilized prior to filling.

Turning back to FIG. 1, in some embodiments, the sealing unit 140 may include a sealing part 142. The sealing part 142 may seal the filled containers 106 to produce sealed containers 108. In some embodiments, the sealing part 142 can be designed to seal the filled containers 106 while the hydrogel material is hot, thus considering fluctuations in volume as the hydrogel material cools (e.g., total volume of air and hydrogel material within the container). According to various embodiments, the filled containers 106 may be sealed by the sealing part 142 via modified atmosphere packaging (MAP) conditions, vacuum conditions, and/or heat-sealing conditions. In certain embodiments, the hydrogel material can be sealed within the filled containers 106 at relatively high temperatures (e.g., at least about 70 to 80-degrees C., 75 to 85-degrees C., or 80 to 90-degrees C.). The filled containers 106 may be packaged and sealed to form sealed containers 108 while the hydrogel material is still relatively hot and relatively low in viscosity, thereby discouraging growth of contaminant bacteria. Thus, in some embodiments, materials used for packaging and/or sealing may be designed to withstand hot temperatures and improve resistance to bacterial growth. Exemplary materials for the sealing/packing include, but are not limited to, aluminum.

Additionally, the hydrogel material within the sealed containers 108 may gradually cool down and increase in firmness, thus conforming to the shape of the containers 108 to form the overall hydrogel product. Thus, in certain embodiments, the packing and sealing materials may include various shapes (e.g., the hydrogel material can take the form of fish fillets based on the shape of the containers). For instance, a lid portion may be removably coupled to the filled containers 106 to form sealed containers 108 such that the lid portion may be stackable with other sealed containers 108 when collected by the collection unit 150.

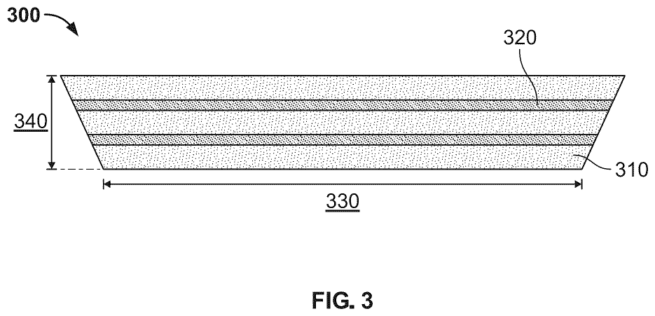

With reference to FIG. 3, an overall hydrogel product 300 may include several layers of alternating first hydrogel components 310 and second hydrogel components 320, according to at least one embodiment. Here, the overall hydrogel product 300 includes five layers while in other embodiments, the overall hydrogel product 300 may include at least two layers or up to 1000 layers. Further, the filling unit 130 may fill the containers such that the overall hydrogel product 300 includes a particular length 330 and a height 340. In one non-limiting example, an overall amount of orange-colored hydrogel material may comprise at least about 65 to 90% of the overall hydrogel product 300 by volume while an overall amount of white-colored hydrogel material may comprise at least about 10 to 35% of the overall hydrogel product by volume. In another non-limiting example, a ratio of the first hydrogel component 310 and the second hydrogel component 320 in the overall hydrogel product 300 by volume may be about 2:1, or about 3:1, or about 4:1, or about 5:1.

Turning again to FIG. 1, in some embodiments, the system 100 may include a database module 102 comprising at least a memory unit, a controller, and a processor designed to receive and store operating preference data, consumer data, and feedback data from other system 100 components. The database module 102 may be operatively coupled with one or more aspects of the system 100 to accomplish the processing tasks as described herein, using feedback data from the various system 100 components. For instance, one or more components of the system 100 (e.g., mixing and extraction unit 109, distribution unit 119, filling unit 130, sealing unit 140, collection unit 150, etc.) may be equipped with one or more sensors that measure and electronically communicate sensed operating parameters to the database module 102 to ensure iterative correction and quality control for the system 100. In some embodiments, the database module 102 can include program instructions that are stored on a cloud server non-transitory computer-readable medium and are executable by the processor to perform one or more of the processes as described herein and as modified by sensor feedback.

In some embodiments, the consumer data may comprise gender, age, weight, height genetic data, bioenergy and nutrient consumption, bioenergy and nutrient intake, physical fitness data, and other health data. Such consumer data can be used by the database module 102 to operate the system 100 to process a customized mixture plant-based materials and derive a customized mixture of extracted biomaterials. Additionally, the consumer data may be provided directly individual consumer input (e.g., via a wearable monitoring and/or diagnostic device) or may be provided via mass-consumer surveys indicating aggregate preferences.

In one non-limiting example, the database 102 module can be programmed with customizable instructions for the system 100 to produce various types of hydrogel products (e.g., vegan/vegetarian fish products, vegan/vegetarian meat products, vegan dairy products, etc.). In another non-limiting example, one or more components of the mixing and extraction unit 109 can include one or more sensors that measure parameters such as temperature, mixture composition (relating to flavor, texture, or color), or viscosity levels. In another non-limiting example, one or more components of the distribution unit 119 can include one or more sensors that measure feed rate. In another non-limiting example, the filling unit 130 can include one or more sensors that measure fill rate or amount to verify the amount of hydrogel product inserted into the containers. In another non-limiting example, the sealing unit 140 can include one or more sensors that sense whether the filled containers are sealed correctly. In another non-limiting example, the collection unit 150 can include one or more sensors that sense whether the collection unit 150 is filled with sealed containers 108.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of manufacturing an edible, plant-based, shelf-stable hydrogel, the method comprising:
selecting a feed source, the feed source comprising one or more plant-based materials;
extracting one or more biomaterials from the one or more plant-based materials;
forming an emulsion from the one or more biomaterials;
extruding an edible hydrogel material from the emulsion;
filling a container with the edible hydrogel material; and
sealing the container.

2. The method of claim 1, wherein an operating temperature is maintained to at least about 70-degrees C. to about 80-degrees C.

3. The method of claim 2, the step of extruding a consumable hydrogel material from the emulsion further comprising:
adding a reticulation agent to the emulsion to prompt thickening.

4. The method of claim 2, further comprising the step of separating the consumable hydrogel material into a first hydrogel component and a second hydrogel component.

5. The method of claim 4, the step of filling a container with consumable hydrogen material further comprising:
dispensing the first hydrogel component along an inner portion of the container; and
dispensing the second hydrogel component atop and along the first hydrogel component.

6. The method of claim 5, wherein a ratio of the first hydrogel component to the second hydrogel component by volume is approximately 3:1.

7. The method of claim 2, wherein the step of sealing the container occurs at MAP conditions.

8. A shelf-stable, layered food, the layered food comprising:
a first layer comprising a first hydrogel component; and
a second layer comprising a second hydrogel component;
wherein the first and second hydrogel components are formed from one or more biomaterials extracted from one or more plant-based sources.

9. The layered food of claim 8, wherein a water content for the layered food is over approximately 25% by weight.

10. The layered food of claim 9, wherein the layered food is resistant to weight loss and spoilage over time.

11. The layered food of claim 8, wherein a ratio of the first hydrogel component to the second hydrogel component by volume is approximately 3:1.

12. The layered food of claim 8, wherein the first layer includes a first color and the second layer includes a second color.

13. The layered food of claim 12, wherein the layered food comprises alternating first and second layers.

14. The layered food of claim 8, wherein a first of the one or more biomaterials comprises carrageenan.

15. A system for manufacturing an edible, plant-based, shelf-stable hydrogel, the system comprising:
a mixture and extraction unit, the mixture and extraction unit configured to extract one or more biomaterials from a plant-based feed material, wherein the one or more biomaterials is processed to form a hydrogel material;
a filling unit, the filling unit configured to extrude the hydrogel material into one or more containers; and
a sealing unit, the sealing unit configured to seal the one or more containers of hydrogel material to form a sealed hydrogel product.

16. The system of claim 15, wherein the mixture and extraction unit is further configured to separate the hydrogel material into a first hydrogel component and a second hydrogel component.

17. The system of claim 16, wherein the first hydrogel component and the second hydrogel component are different.

18. The system of claim 17, further comprising a distribution unit configured to transport the first hydrogel component and the second hydrogel component from the mixture and extraction unit to the filling unit via one or more feeding components.

19. The system of claim 18, wherein the filling unit further comprises a dosing component configured to:
receive the first hydrogel component and the second hydrogel from the one or more feedings components, and
dispense the first hydrogel component and the second hydrogel in a pattern into the one or more containers.

20. The system of claim 19, wherein a ratio of the first hydrogel component to the second hydrogel component by volume is approximately 3:1.
